(19) United States
(12) Patent Application Publication
(10) Pub. No.: US 2017/0048307 A1
(43) Pub. Date: Feb. 16, 2017

(54) APPARATUS AND METHOD TO PERFORM POST-INITIALIZATION CONTROL ON APPLICATIONS IN A SERVER

(71) Applicant: FUJITSU LIMITED, Kawasaki-shi (JP)

(72) Inventor: Tsutomu KAWAI, Kawasaki (JP)

(73) Assignee: FUJITSU LIMITED, Kawasaki-shi (JP)

(21) Appl. No.: 15/214,740

(22) Filed: Jul. 20, 2016

(30) Foreign Application Priority Data
Aug. 12, 2015 (JP) 2015-159333

(51) Int. Cl. H04L 29/08; H04L 29/06; H04L 12/24

(52) U.S. Cl. CPC H04L 67/1002; H04L 41/0803; H04L 67/42; H04L 67/26

(57) ABSTRACT

An apparatus acquires a number of executable units of application programs to be executed by a server, in response to a notification indicating completion of initialization of the application programs. The apparatus transmits, to the server, a stop instruction to stop operations of all the executable units to be executed by the server, transmits, to the server, requests whose number is equal to or greater than the acquired number of the executable units, and transmits, to the server, a restart instruction to restart operations of all the executable units that have been stopped.

### CROSS-REFERENCE TO RELATED APPLICATION

This application is based upon and claims the benefit of priority of the prior Japanese Patent Application No. 2015-159333, filed on Aug. 12, 2015, the entire contents of which are incorporated herein by reference.

### FIELD

The embodiment discussed herein is related to apparatus and method to perform post-initialization control on applications in a server.

### BACKGROUND

As one usage of cloud services, a user client uses an application that operates in a server configured to provide a service. The application that operates in the server may be modified, changed, or the like. In such a case, the application is initialized.

As related art, a technique has been proposed to execute an updated master warm-up program so as to dynamically reinitialize contexts upon the initialization of a process or in response to a command from an application manager.

In addition, a technique has been proposed to temporarily stop an operation of an active process or large process group to be copied in an active control unit and maintain another process of the active control unit in an operating state.

Furthermore, a technique has been proposed to operate a process of an operating system or an application program as a thread under a single process that has been prepared in a system, without switching of processes. Refer to Japanese Laid-open Patent Publication No. 2005-216288, Japanese National Publication of International Patent Application No. 9-507983, and Japanese Laid-open Patent Publication No. 2001-331331.

### SUMMARY

According to an aspect of the invention, an apparatus acquires a number of executable units of application programs to be executed by a server, in response to a notification indicating completion of initialization of the application programs. The apparatus transmits, to the server, a stop instruction to stop operations of all the executable units to be executed by the server, transmits, to the server, requests whose number is equal to or greater than the acquired number of the executable units, and transmits, to the server, a restart instruction to restart operations of all the executable units that have been stopped.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration, according to an embodiment;

FIG. 2 is a diagram illustrating an example of a functional configuration of a server control device, according to an embodiment;

FIG. 3 is a diagram illustrating an example of a server management table, according to an embodiment;

FIG. 4 is a diagram illustrating an example of an application management table, according to an embodiment;

FIG. 5 is a diagram illustrating an example of a control-side thread management table, according to an embodiment;

FIG. 6 is a diagram illustrating an example of a server-side thread management table, according to an embodiment;

FIG. 7 is a diagram illustrating an example of an operational flowchart for a system, according to an embodiment;

FIG. 8 is a diagram illustrating an example of an operational flowchart for a post-initialization control process, according to an embodiment;

FIG. 9 is a diagram illustrating an example of an operational flowchart for a post-initialization control process, according to an embodiment;

FIG. 10 is a diagram illustrating an example of an operational flowchart for a post-initialization control process, according to an embodiment;

FIG. 11 is a diagram illustrating an example of an operational flowchart for a process of stopping threads, according to an embodiment;

FIG. 12 is a diagram illustrating an example of an operational flowchart for a process of stopping a target thread, according to an embodiment;

FIG. 13 is a diagram illustrating an example of an operational flowchart for a process of restarting threads, according to an embodiment;

FIG. 14 is a diagram illustrating an example of an operational flowchart for a process of restarting a target thread, according to an embodiment;

FIG. 15 is a diagram illustrating an example of an operational flowchart for a process of confirming execution states, according to an embodiment;

FIG. 16 is a diagram illustrating an example of an operational flowchart for a process of confirming an execution state of a target thread, according to an embodiment;

FIG. 17 is a diagram illustrating an example of an operational flowchart for a process of confirming an execution state of a target thread, according to an embodiment;

FIG. 18 is a diagram illustrating an example of an operational flowchart for a process of restarting all threads, according to an embodiment; and

FIG. 19 is a diagram illustrating an example of a hardware configuration of a server control device, according to an embodiment.

### DESCRIPTION OF EMBODIMENT

When an application (application program) is initialized, the application becomes able to be executed.

The response performance of a server when an application returns a response to a request transmitted by a client is reduced due to the fact that information to be used for the execution of the application is not loaded when initially executing the application.

It is preferable to suppress a reduction in the response performance of a server with respect to a request provided to an application program after initialization.

Example of System

Hereinafter, an example of a system according to an embodiment is described with reference to the accompanying drawings. A system 1 according to the embodiment includes a client 2, multiple servers 3, server load balancing 4, a server control device 5, and a database 6.

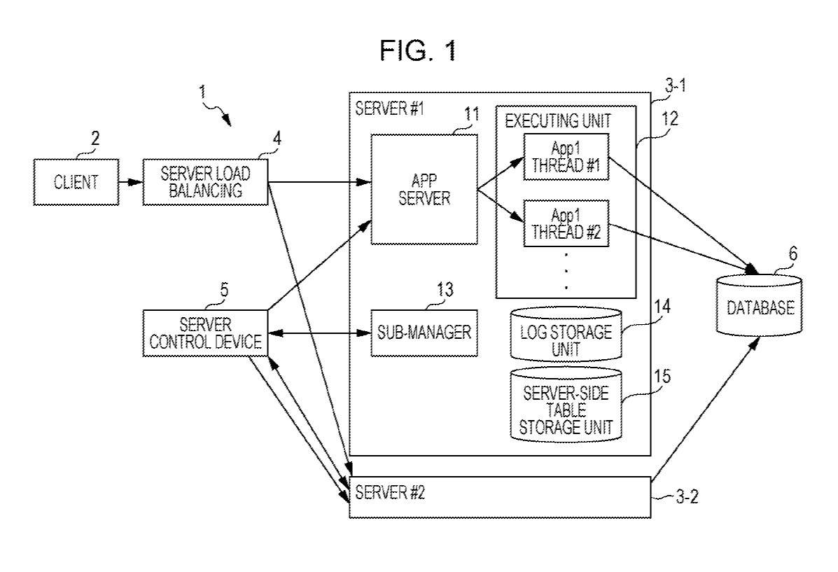

FIG. 1 exemplifies a case where the single client 2 is provided. The number of clients 2, however, may be two or more. FIG. 1 exemplifies the multiple servers 3 (server 3-1 and server 3-2). The number of servers 3, however, may be 1 or 3 or more.

The servers 3 may be physical computers or virtual computers. For example, the servers 3-1 and 3-2 may be virtual computers achieved in a single physical computer.

The server load balancing 4 is referred to as SLB in some cases. The server load balancing 4 outputs and distributes requests received from the client 2 to the servers 3. Application programs (hereinafter merely referred to as applications) that operate in the servers return responses to the received requests to the client 2.

The server control device 5 controls the servers 3. The server control device 5 according to the embodiment executes control so as to suppress reductions in the response performance of the servers 3 with respect to the requests transmitted by the client 2 to the applications after the applications operating in the servers 3 are initialized.

The database 6 stores information of various types that is used by the applications operating in the servers 3.

Next, the servers 3 are described below. Each of the servers 3 includes an app server 11, an executing unit 12, a sub-manager 13, a log storage unit 14, and a server-side table storage unit 15. The app server 11 is an application server.

The app server 11 manages an application operating in the server 3. In the embodiment, the application is divided into multiple threads. In the example illustrated in FIG. 1, a thread #1 and thread #2 of an application App1 are illustrated.

The threads are an example of executable units of an application. The executable units of the application may be processes, for example. The multiple threads or the multiple processes may be executed in parallel. Since the application is achieved by a program, the executable units such as the threads or the processes are achieved by the program.

The app server 11 assigns requests received from the client 2 to the threads of the application. In addition, the app server 11 assigns requests received from the server control device 5 to the threads of the application.

In the executing unit 12, the threads of the application App1 are executed in response to requests. The executing unit 12 may include not only the application App1 but also threads of multiple applications.

The sub-manager 13 executes predetermined control on the app server 11 and the threads of the application. In addition, the sub-manager 13 references information stored in the log storage unit 14. Furthermore, the sub-manager 13 causes predetermined information to be stored in a table stored in the server-side table storage unit 15 and references the stored information.

In the embodiment, functions of the app server 11, executing unit 12, and sub-manager 13 are achieved by a program operating in the server 3.

The log storage unit 14 stores logs (hereinafter referred to as app server logs) related to the application managed by the app server 11 or logs (hereinafter referred to as app logs) related to applications. If the logs are not used, the server 3 may not include the log storage unit 14.

The applications executed in the server 3 may be modified, updated, or the like. Data of the applications to be modified or updated is also referred to as patches. When an application is modified or updated, the server 3 initializes the application. By the initialization, the application becomes able to be executed.

For example, as one of methods of modifying or updating an application, there is a method that is referred to as rolling update. In the rolling update, one of the multiple servers 3 is removed and an application that operates in the removed server 3 is modified, updated, or the like.

Thus, the applications are modified, updated, or the like without the stop of operations of services achieved by the multiple servers 3. The modified or updated applications are initialized by the servers 3 and thereby become able to be executed.

In addition, when a server 3 is activated (for example, when a power source of the server 3 is turned on), an application that operates in the server 3 is initialized. When the application is initialized and has yet to be executed, information to be used by the application (for example, a program code of the application or the like) has yet to be loaded.

In addition, when the application is initialized and has yet to be executed, a connection to another resource has yet to be established. In this case, a connection between the server 3 and the database 6 has yet to be established, for example.

Thus, when the application after the initialization is executed for the first time (initially) in response to a request from the client 2, a process of loading the aforementioned information, the establishment of the connection, and the like are executed and thus it takes a predetermined time. The response performance of a server 3 with respect to the request transmitted by the client 2, therefore, is reduced.

The client 2 transmits a request to execute the application to the server 3. The app server 11 assigns the received request to threads of the application, thereby causing the threads to be executed.

In this case, when the application is not executed after the initialization, the response performance of the server 3 with respect to the request provided to the application is reduced and thus the speed of a response to the request from the client 2 is reduced.

In the embodiment, the server control device 5 executes predetermined control (hereinafter referred to as post-initialization control) on a server 3 in which an application, which has not been executed yet after initialization of the application, is operated, thereby suppressing a reduction in the response performance of the server 3. The post-initialization control is also referred to as warm-up control.

Example of Server Control Device

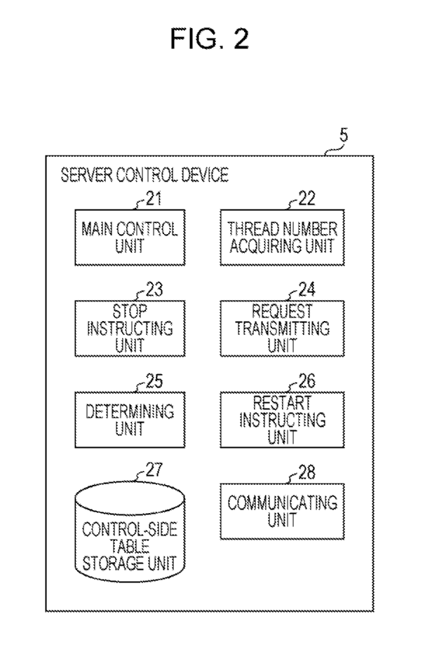

Next, the server control device 5 is described with reference to FIG. 2. The server control device 5 includes a main control unit 21, a thread number acquiring unit 22, a stop instructing unit 23, a request transmitting unit 24, a determining unit 25, a restart instructing unit 26, a control-side table storage unit 27, and a communicating unit 28.

The main control unit 21 performs the overall control on the server control device 5. The thread number acquiring unit 22 acquires, from a sub-manager 13 included in a server 3, the number of threads of applications to be subjected to the post-initialization control. The thread number acquiring unit 22 is an example of an acquiring unit configured to acquire the number of executable units.

The stop instructing unit 23 transmits, to the sub-manager 13, an instruction (operation stop instruction) to stop (suspend) operations of all the threads of applications to be subjected to the post-initialization control. Based on the operation stop instruction, the sub-manager 13 of the server 3 causes each of the threads of the applications to stop the operation thereof. Thus, the execution of each thread is stopped.

The request transmitting unit 24 executes control to transmit, to the server 3, requests whose number is equal to or greater than the number of the threads acquired by the thread number acquiring unit 22. The requests to be transmitted may be dummy requests, for example. The request transmitting unit 24 is an example of a transmitting unit.

The determining unit 25 makes predetermined determination in order to execute the post-initialization control. The restart instructing unit 26 transmits, to the sub-manager 13, an instruction (operation restart instruction) to restart (resume) operations of all the stopped threads.

The sub-manager 13 of the server 3 restarts the operations of the stopped threads, based on the operation restart instruction. The sub-manager 13 uses a function of the OS of the server 3 to restart the operations of the threads, for example.

The control-side table storage unit 27 stores various tables which are to be referenced in order to execute the post-initialization control. The communicating unit 28 communicates with the servers 3, by control of the thread number acquiring unit 22, the stop instructing unit 23, the request transmitting unit 24, and the restart instructing unit 26.

Example of Various Tables

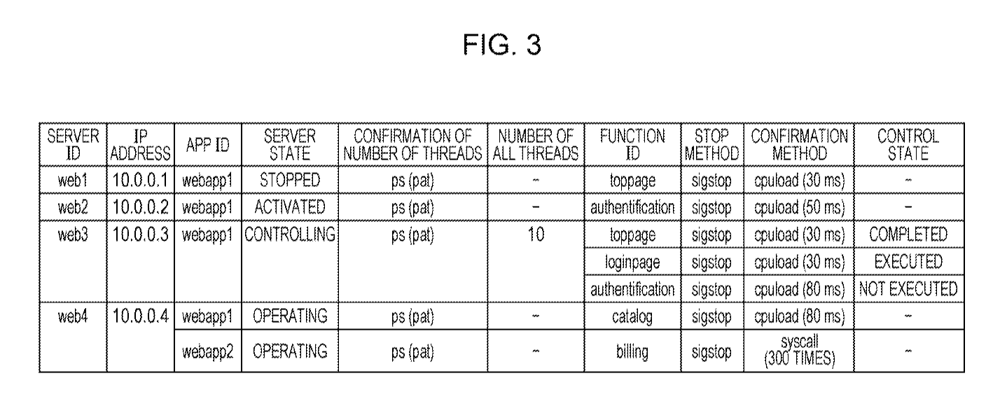

Next, examples of the various tables are described. FIG. 3 illustrates an example of a server management table stored in the control-side table storage unit 27 of the server control device 5. The server management table is used to manage the multiple servers 3 to be controlled by the server control device 5.

The server management table illustrated in the example of FIG. 3 includes fields for a server ID, an IP address, an app ID, a server state, confirmation of the number of threads, the number of all threads, a function ID, a stop method, a confirmation method, and a control state. ID is abbreviations for identifications, and IP is an abbreviation for the Internet Protocol.

The server ID is identifier identifying the server 3. The IP address indicates an IP address of the server 3 that is associated with the server ID. The app ID is an identifier identifying an application. The server state indicates the state of the server 3.

In the example illustrated in FIG. 3, “stopped” indicates that a server 3 is in a stopped state, “activated” indicates that a server 3 is being activated but the initialization thereof is not completed, “controlling” indicates that a server 3 is executing the post-initialization control, and “operating” indicates that a server 3 is operating.

The confirmation of the number of threads indicates a method of confirming the number of threads of applications operating in the servers 3. In the example of FIG. 3, ps(pat) indicates a method of confirming the number of threads by acquiring a process list of an operating system and determining whether or not a target thread matches a specified pattern. The method of acquiring the number of threads may be another method. The number of all threads indicates the number of all the threads for each of functions of an application identified by the app ID.

Functions are described below. The function ID is an identifier identifying a function included in the applications. The embodiment assumes that the applications are web applications that each include multiple functions.

The applications, however, are not limited to the web applications. In addition, the number of functions included in each of the applications may be 1.

For example, in the example illustrated in FIG. 3, “toppage” is a function of displaying a top page of a web application, “loginpage” is a function of displaying a login screen, and “authentication” is a function of executing authentication.

As illustrated in the example of FIG. 3, threads of the application identified by the app ID are threads that execute each of the functions of the application. In the example illustrated in FIG. 3, if the number of threads identified by an app ID is 10, the number of the threads that execute each of the functions is also 10.

The stop method is a method of stopping operations of threads. In the example illustrated in FIG. 3, “sigstop” indicates a method of stopping threads by instructing an operating system to stop the threads. The method of stopping threads may be another method.

The confirmation method is a method of determining whether or not a thread is being executed. In the example illustrated in FIG. 3, “cpuload(30 ms)” indicates a method of confirming, based on an increase in a load of a central processing unit (CPU), whether or not a thread is being executed. In an example of “cpuload(30 ms)”, it is confirmed whether or not a thread is being executed, based on whether or not an increase in the CPU load exceeds a threshold of “30 ms” (hereinafter referred to as a load threshold).

In addition, “syscall(300 times)” is a method of confirming whether or not a thread is being executed, based on whether or not the number of times a system call is issued by the thread exceeds a threshold of “300 times” (hereinafter referred to as an issuance threshold).

The control state indicates the execution state of the post-initialization control according to the embodiment. “Completed” indicates that the post-initialization control has been completed on a function identified by the function ID. “Executed” indicates that the initialization control is being executed on a function identified by the function ID. “Not executed” indicates that the initialization control has not been executed on a function identified by the function ID.

For example, when recognizing that the post-initialization control according to the embodiment has been completed, the main control unit 21 of the server control device 5 may set a control state at “completed”. In addition, when the main control unit 21 starts but has yet to complete the post-initialization control according to the embodiment, the main control unit 21 may set the control state at “executed”. In the embodiment, the number of functions that is set at “executed” in a single server 3 is 1.

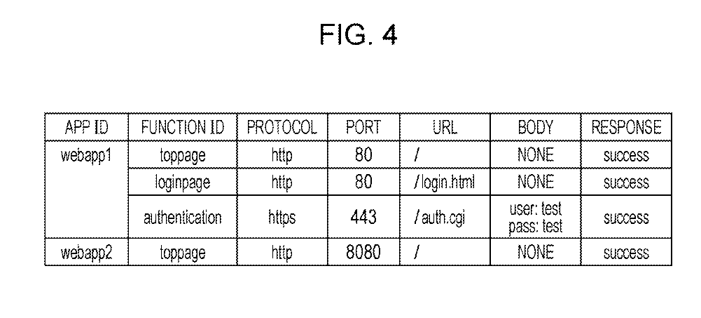

Next, an example of an application management table is described with reference to an example illustrated in FIG. 4. The application management table is stored in the control-side table storage unit 27. The application management table includes fields for an app ID, a function ID, a protocol, a port, a URL, a body, and a response.

The protocol indicates a protocol of a function identified by the function ID. The port indicates a port number of a function identified by the function ID. The Uniform Resource Locator (URL) indicates a URL of a function identified by the function ID.

The body indicates information on a function identified by the function ID. The response indicates a response expected for a function identified by the function ID. In the example illustrated in FIG. 4, the response that simply indicates success is expected to be returned. However, a response that includes a specific detail and a response that indicates a failure may be expected to be returned.

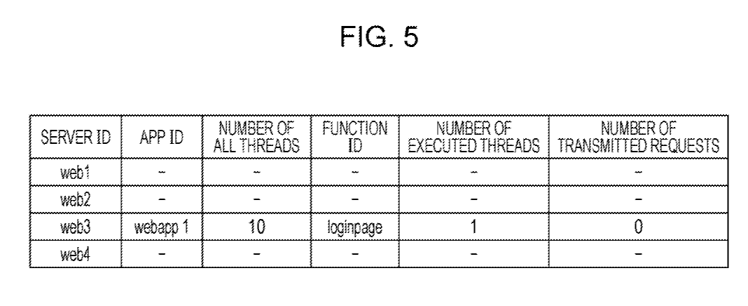

Next, an example of the control-side thread management table is described with reference to FIG. 5. The control-side thread management table is stored in the control-side table storage unit 27. The control-side thread management table includes fields for a server ID, an application ID, the number of all threads, a function ID, the number of executed threads, and the number of transmitted requests.

The number of executed threads indicates the number of threads, out of threads of a function identified by the function ID, which have executed the requests transmitted by the server control device 5. The number of transmitted requests indicates the number of requests transmitted by the server control device 5 to an app server 11 that manages applications to be subjected to the post-initialization control.

During the execution of the post-initialization control, the number of executed threads and the number of transmitted requests are updated in the control-side thread management table on an as needed basis.

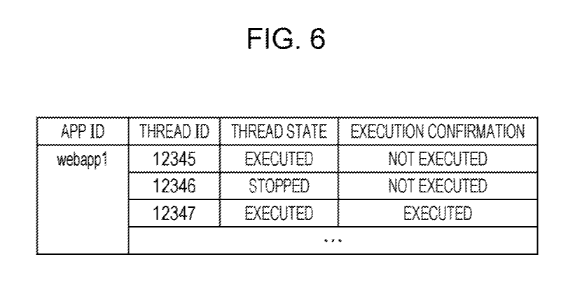

Next, an example of the server-side thread management table is described with reference to FIG. 6. The server-side thread management table is stored in the server-side table storage units 15 of the servers 3. The server-side thread management table includes fields for an app ID, a thread ID, a thread state, and execution confirmation.

The thread ID is an identifier identifying a thread. The thread state indicates whether the thread identified by the thread ID is being executed or stopped (suspended). The execution confirmation indicates whether or not the thread identified by the thread ID has executed a request transmitted by the server control device 5.

When the execution confirmation indicates “not executed”, it is not confirmed that a thread has executed a request. When the execution confirmation indicates “executed”, it was confirmed that the thread has executed the request.

Flowchart of Example of Process According to Embodiment

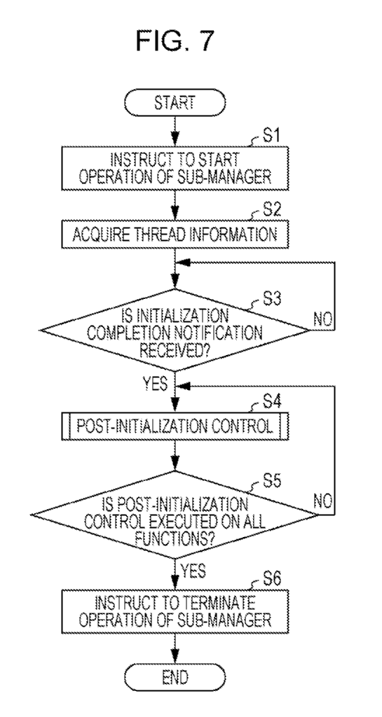

Next, an example of a process according to the embodiment is described with reference to a flowchart of FIG. 7. The main control unit 21 of the server control device 5 transmits, to a server 3, an instruction (operation start instruction) to start an operation of a sub-manager 13 (in step S1).

The sub-manager 13 of the server 3 starts operating based on the operation start instruction. When the sub-manager 13 starts operating, information held by the sub-manager 13 is set at initial values.

As described above, the sub-manager 13 is a program that operates in the server 3. Thus, when the server control device 5 transmits the operation start instruction, the server control device 5 may execute control so as to generate a new sub-manager 13 in the server 3.

The thread number acquiring unit 22 acquires, from the sub-manager 13, thread information including the number of threads of applications (in step S2).

For example, the sub-manager 13 uses a function of the OS of the server 3 to recognize the number of the threads of the applications and transmits the thread information including the recognized number of the threads to the server control device 5 in accordance with an acquire request from the thread number acquiring unit 22. Thus, the thread number acquiring unit 22 acquires the thread information.

When an application that operates in the server 3 is initialized, the sub-manager 13 detects that the application was initialized. Based on the detection, the sub-manager 13 transmits, to the server control device 5, a notification (initialization completion notification) indicating that the initialization of the application was completed.

The main control unit 21 of the server control device 5 determines whether or not the communicating unit 28 has received the initialization completion notification (in step S3). When the communicating unit 28 has not received the initialization completion notification (NO in step S3), the process does not proceed to the next step.

When the communicating unit 28 has received the initialization completion notification (YES in step S3), the server control device 5 executes the post-initialization control (in step S4). In the embodiment, the server control device 5 executes the post-initialization control on each of functions of the application. The post-initialization control may be executed on a single application.

The main control unit 21 of the server control device 5 determines whether or not the post-initialization control has been completed on all the functions of the application (in step S5). When the post-initialization control is not completed on at least any of all the functions of the application (NO in step S5), the process returns to step S4.

When the post-initialization control has been completed on all the functions of the application (YES in step S5), the main control unit 21 transmits, to the sub-manager 13 of the server 3, an instruction (operation termination instruction) to terminate the operation of the sub-manager 13 (in step S6). Then, the process is terminated.

In step S6, the main control unit 21 may transmit, to the server 3, an instruction to delete the sub-manager 13. Since the sub-manager 13 completes the role at the time of step S6, the sub-manager 13 may be deleted from the server 3. Since the sub-manager 13 is achieved by the program, the amount of a resource consumed by the server 13 is reduced by the deletion of the sub-manager 13.

Example of Process for Post-Initialization Control

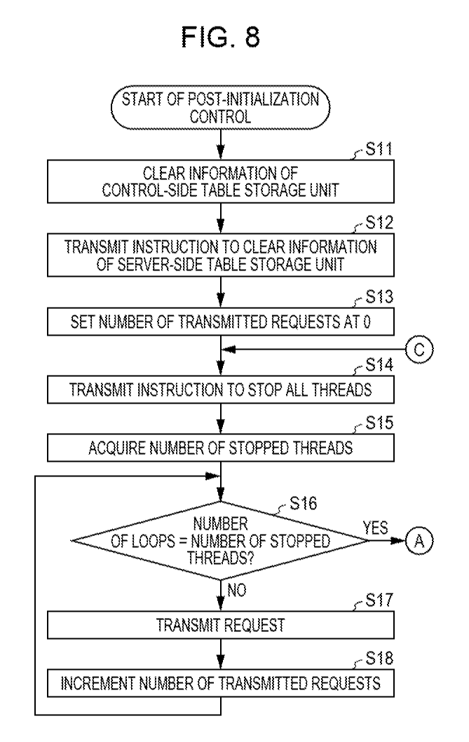

Next, an example of a process for the post-initialization control is described with reference to flowcharts of FIGS. 8 to 10. The main control unit 21 clears predetermined information among information included in the various tables stored in the control-side table storage unit 27 (in step S11).

For example, the main control unit 21 clears (sets at initial values) the control states indicated in the server management table illustrated in FIG. 3. In addition, the main control unit 21 sets the number of executed threads and the number of transmitted requests at 0 in the control-side thread management table illustrated in FIG. 5.

The main control unit 21 transmits, to the sub-manager 13, an instruction to clear information stored in the server-side table storage unit 15 of the server 3 (in step S12). The sub-manager 13 clears the information stored in the server-side thread management table of the server-side table storage unit 15 based on the instruction.

For example, the sub-manager 13 sets, at initial values, the thread states and the execution confirmation in the server-side thread management table illustrated in FIG. 6.

The request transmitting unit 24 manages the number of transmitted requests. Thus, the request transmitting unit 24 sets the number, indicated in the control-side thread management table, of transmitted requests at 0 (in step S13).

Next, the stop instructing unit 23 transmits, to the sub-manager 13, an operation stop instruction to stop operations of all the threads of the application to be subjected to the post-initialization control (in step S14). The sub-manager 13 uses a function of the OS of the server 3 to stop the operations of the threads, for example.

The thread number acquiring unit 22 transmits, to the sub-manager 13, a request to acquire the number of stopped threads. In accordance with the acquire request, the sub-manager 13 uses a function of the OS to recognize the number of the stopped threads and transmits information indicating the recognized number of the stopped threads to the server control device 5.

Thus, the thread number acquiring unit 22 acquires the number of stopped threads (in step S15). The number of the stopped threads at the time of step S15 executed for the first time is equal to the number of the threads of the application.

The determining unit 25 determines whether or not the number of loops reached the number of the stopped threads (in step S16). Steps S17 and S18 are repeatedly executed. The number of loops is the number of times steps S17 and S18 are executed.

When the number of loops does not reach the number of the stopped threads (NO in step S16), the request transmitting unit 24 transmits a request to the app server 11 (in step S17) and increments the number of transmitted requests (in step S18).

Thus, each time the process of step S18 is executed, the number of transmitted requests in the control-side thread management table is incremented.

When the process of step S17 is executed once, a single request is transmitted to the server 3. When the number of loops reached the number of the stopped threads (YES in step S16), the server control device 5 has already transmitted requests whose number is equal to the number of the stopped threads.

The transmission of the requests by the server control device 5 will be described below. As described above, upon the initial execution of the application after the initialization, the response performance of the server 3 with respect to a request provided to the application is reduced.

Thus, when the application after the initialization is not executed, the response performance of the server 3 with respect to a request transmitted by the client 2 to the application is reduced. Thus, the speed of a response to the request transmitted by the client 2 to the application is reduced.

In the embodiment, the server control device 5 transmits, to the app server 11, requests whose number is equal to the number, acquired in step S15, of the threads, in response to the reception of the initialization completion notification.

The app server 11 allocates the received request to each of the threads of the application. The thread to which the request has been allocated is executed based on the request. When the thread is executed, information to be used by the thread is loaded and a connection to another resource is established.

Thus, the speed of the execution of executed thread is higher than that of the execution of unexecuted thread. Thus, the response performance of the server 3 with respect to requests allocated to the executed threads is improved.

The speed of the execution of unexecuted thread is lower than that of the execution of executed thread. Thus, when the number of unexecuted threads is large, it is not expected that the effect of suppressing a reduction in the response performance of the server 3 is high.

The app server 11 receives, from the server control device 5, the requests whose number is equal to the number of the threads of the application. However, when the threads of the application are being executed, the app server 11 does not evenly allocate the received requests to the threads. Thus, allocation of the requests may be significantly biased.

Therefore, the stop instructing unit 23 transmits, to the sub-manager 13, an operation stop instruction to stop the operations of all the threads of the application to be subjected to the post-initialization control. The sub-manager 13, for example, stops the operation of each of the threads, by providing the instruction to stop a thread using a function of the OS of the server 3.

When the operation of each thread is stopped, the each thread becomes busy state. When all the threads become the busy states, the probability that the app server 11 evenly allocate the received requests to the threads increases.

In this case, since the requests are evenly or almost evenly allocated by the app server 11, the number of unexecuted threads becomes smaller and the number of executed threads becomes larger. Thus, a reduction in the response performance of the server 3 with respect to the requests provided to the application is suppressed. Accordingly, the stop instructing unit 23 is configured to transmit the operation stop instruction to the app server 11.

However, even if the operation of each of the threads is stopped, there is a probability that the app server 11 does not allocate the requests received from the server control device 5 to all the threads. In this case, there exists a thread to which a request is not allocated.

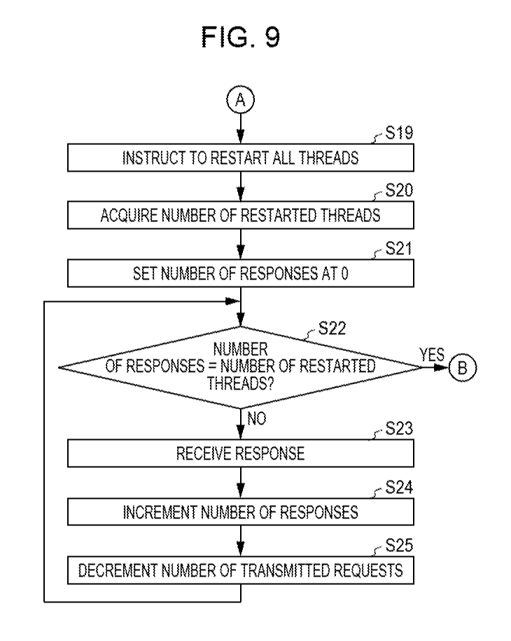

When the answer to step S16 is YES, the process proceeds to “A”. Processes after “A” are described with reference to the flowchart of FIG. 9. The restart instructing unit 26 transmits, to the sub-manager 13, an operation restart instruction to restart the operations of all the stopped threads (in step S19).

The sub-manager 13 executes control to restart the threads in accordance with the operation restart instruction. Out of the thread, threads to which the requests have been allocated restart operations thereof. On the other hand, threads to which requests have not been allocated do not restart operations thereof.

The sub-manager 13 uses the function of the OS of the server 3 to recognize the number (of restarted threads) of threads, among the threads, whose operations have been restarted, and the sub-manager 13 transmits information indicating the number of the restarted threads to the server control device 5, for example.

Thus, the server control device 5 acquires the information indicating the number of the restarted threads (in step S20). When the app server 11 has allocated the requests to all the threads, the number of the restarted threads is equal to the number of all the threads of the application.

The determining unit 25 sets the number of responses at 0 (in step S21). Then, the determining unit 25 determines whether or not the number of responses is equal to the number of the restarted threads (in step S22).

When the operations of threads to which the requests were allocated are restarted, the threads are executed and the executed threads transmit responses to the server control device 5. The communicating unit 28 receives the responses (in step S23).

When the communicating unit 28 receives the responses, the determining unit 25 increments the number of responses (in step S24). In addition, the determining unit 25 decrements the number of transmitted requests (in step S25). Then, the process returns to step S22.

Each time the communicating unit 28 receives a response, the processes of steps S23 to S25 are executed. When the determining unit 25 determines that the number of responses is equal to the number of the restarted threads (YES in step S22), the process proceeds to “B”.

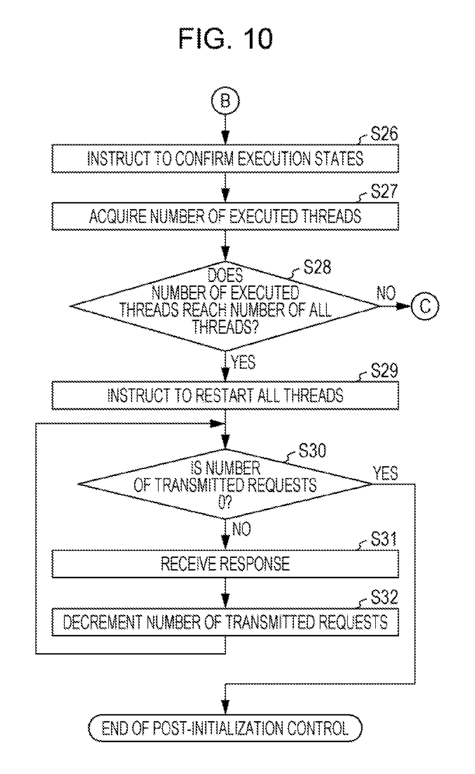

Processes after “B” are described below with reference to the flowchart of FIG. 10. The main control unit 21 transmits, to the sub-manager 13, an instruction (execution state confirmation instruction) to confirm execution states indicating whether or not the threads are already executed (in step S26).

The sub-manager 13 confirms whether or not each of the threads has been already executed. The sub-manager 13 may confirm, based on logs stored in the log storage unit 14, whether or not the threads have been already executed.

In addition, the sub-manager 13 may confirm whether or not each of the threads has been already executed, based on whether or not an increase in a CPU load applied to each thread exceeds a load threshold or whether or not the number of times a system call is issued exceeds an issuance threshold.

When the app server 11 or the application has a function of confirming the execution states of the threads, the sub-manager 13 may use the function to confirm whether or not the threads have been already executed.

The sub-manager 13 confirms the execution states of the threads and transmits information indicating the number of executed threads to the server control device 5. Thus, the server control device 5 acquires the number of the executed threads (in step S27).

The main control unit 21 causes the acquired number of the executed threads to be stored as the number of executed threads in the control-side thread management table. The determining unit 25 determines whether or not the acquired number of the executed threads reached the number of all the threads of the application (in step S28).

As described above, the stop instructing unit 23 stops the operations of the threads of the application, thereby allowing the app server 11 to allocate the received requests to a larger number of threads.

The app server 11 allocates the requests to all the threads in some cases. However, there may be a case where the app server 11 does not allocate the requests to a part of the threads. In this case, even if operations of threads to which requests are allocated are restarted, the threads are not executed.

In this case, the number of executed threads does not reach the number of all the threads of the application (NO in step S28). In the embodiment, the server control device 5 causes all the threads of the application operating in the server 3 to be executed.

Thus, when the answer to step S28 is NO, the process returns to step S14 from “C”. Then, the processes of steps S14 to S27 are repeated until the number of executed threads reaches the number of all the threads of the application.

Thus, all the threads of the application operating in the server 3 are executed and the speed of the execution of the application is higher than that at a time immediately after the application is initialized. Thus, a reduction in the response performance of the server 3 with respect to requests transmitted to the application is suppressed.

In the embodiment, the server control device 5 causes all the threads of the application to be executed, but at least any of all the threads of the application may not be executed. As described above, the server control device 5 stops the operations of the threads and transmits the requests after the stop of the operations of the threads.

This allows the app server 11 to allocate requests to a larger number of threads. Then, the operations of the threads to which the requests were allocated are restarted, thereby allowing a larger number of threads to be executed.

Accordingly, a reduction in the response performance of the server 3 with respect to the requests transmitted to the application is suppressed.

When the number of executed threads reached the number of all the threads (YES in step S28), the restart instructing unit 26 transmits, to the sub-manager 13, an instruction to restart all the threads (in step S29).

As described above, the stop instructing unit 23 stops the operations of the threads. In addition, the restart instructing unit 26 restarts the operations of the threads. In this case, an operation of a part of the threads may not be restarted.

Therefore, in step S29, the restart instructing unit 26 transmits, to the server 3, an instruction to restart the operations of all the threads. The determining unit 25 determines whether or not the number of transmitted requests is 0 (in step S30).

When the operations of all the threads are restarted at the time of step S29, the number of transmitted requests is 0 (YES in step S30). In this case, the post-initialization control is terminated.

On the other hand, when an operation of a part of the threads is not restarted at the time of step S29, the number of transmitted requests is not 0 (NO in step S30). In this case, the operation of the part of the threads is restarted by step S29 and the communicating unit 28 receives a response (in step S31).

When the communicating unit 28 receives the response, the main control unit 21 decrements the number of transmitted requests (in step S32).

The processes of steps S31 and S32 are repeated until the number of transmitted requests becomes 0.

Hereinafter, processes to be executed by the sub-manager 13 will be described below. The sub-manager 13 is controlled by the server control device 5. Thus, the processes to be executed by the sub-manager 13 are based on control by the server control device 5.

Example of Process of Stopping Threads

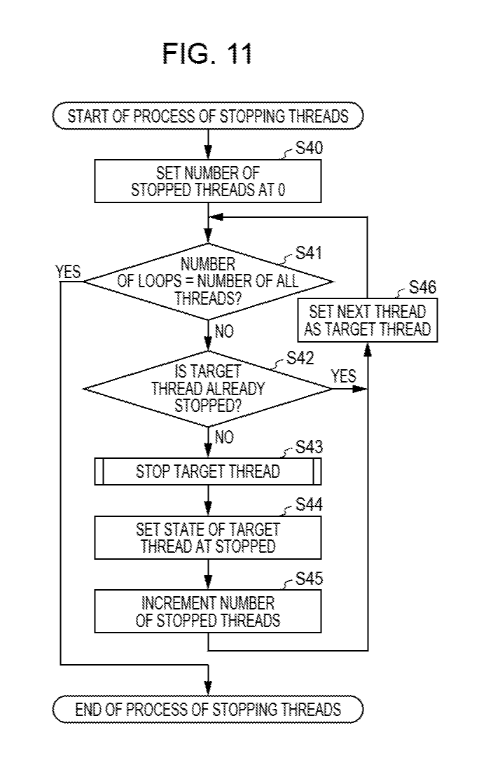

Next, an example of a process of stopping threads is described with reference to a flowchart of FIG. 11. The process of stopping threads is executed by the sub-manager 13 based on an operation stop instruction from the stop instructing unit 23 of the server control device 5.

The sub-manager 13 sets the number of stopped threads at 0 (in step S40). The sub-manager 13 determines whether or not the number of loops reached the number of all the threads (in step S41). The number of loops is the number of times steps S42 to S46 are executed.

The sub-manager 13 sets one of the threads of the application as a target thread. The sub-manager 13 determines whether or not the target thread is already stopped (in step S42).

When the target thread is not stopped (NO in step S42), the sub-manager 13 stops the target thread (in step S43). The sub-manager 13 sets a thread state of the target thread at “stopped” in the server-side thread management table (in step S44).

The sub-manager 13 increments the number of stopped threads (in step S45). The sub-manager 13 sets a next one of the threads as the target thread (in step S46). Then, the process returns to step S41.

When the target thread is already stopped (YES in step S42), the processes of steps S43 to S45 are not executed and the process of step S46 is executed. When the number of loops reached the number of all the threads (YES in step S41), the process of stopping the threads is terminated.

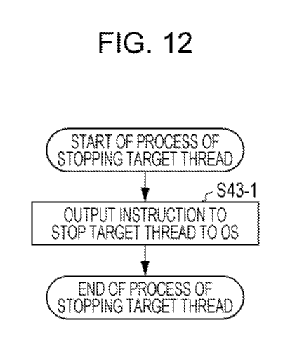

FIG. 12 illustrates an example of the process of step S43. The sub-manager 13 outputs an instruction to stop the target thread to the OS of the server 3 (in step S43-1). The OS of the server 3 stops the target thread based on the instruction. The method of stopping the thread is not limited to the example of FIG. 12.

Example of Process of Restarting Threads

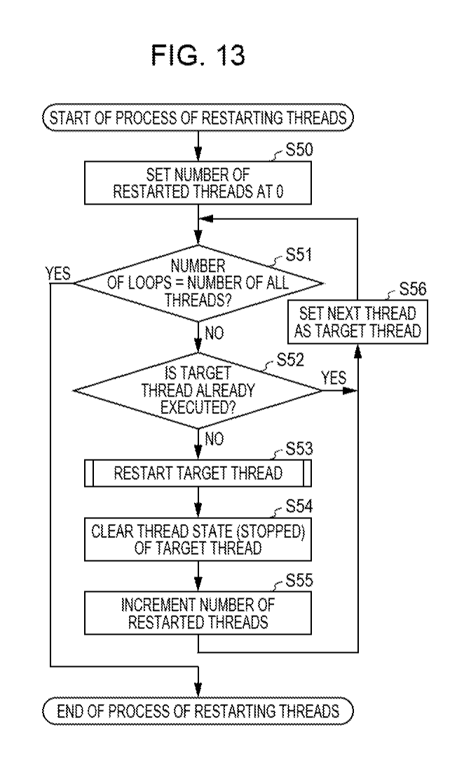

Next, an example of a process of restarting threads is described with reference to a flowchart of FIG. 13. The process of restarting threads is executed by the sub-manager 13 based on an operation restart instruction from the restart instructing unit 26 of the server control device 5.

The sub-manager 13 sets the number of restarted threads at 0 (in step S50). The sub-manager 13 determines whether or not the number of loops reached the number of all the threads (in step S51). The number of loops is the number of times steps S52 to S56 are executed.

The sub-manager 13 sets one of the threads of the application as a target thread. The sub-manager 13 determines whether or not the target thread is already executed (in step S52).

The sub-manager 13 references the execution confirmation of the target thread in the server-side management table and determines whether or not the target thread is already executed. As described above, when the answer to step S28 is NO, the processes of steps S14 to S27 are repeated.

When the process of restarting threads is executed for the first time, there exist no executed threads among the threads of the application. When the process of restarting threads is executed for the second time or later, there exists an executed thread among the threads of the application.

When the target thread is not executed (NO in step S52), the sub-manager 13 restarts the target thread (in step S53). The sub-manager 13 clears the thread state “stopped” set for the target thread in the server-side thread management table (in step S54).

The sub-manager 13 increments the number of restarted threads (in step S55). The sub-manager 13 sets a next one of the threads as the target thread (in step S56). Then, the process returns to step S51.

When the target thread is already executed (YES in step S52), the processes of steps S53 to S55 are not executed and the process of step S56 is executed. When the number of loops reached the number of all the threads (YES in step S51), the process of stopping threads is terminated.

Thus, the processes of steps S53 to S55 that are to be executed by the sub-manager 13 are not executed on executed threads among the threads of the application, thereby omitting processing to be performed by the sub-manager 13. Thus, since the executed threads are maintained in stopped states and requests are not processed, it is expected that the app server does not allocate additional requests to the threads by determining that the threads are in highly loaded states.

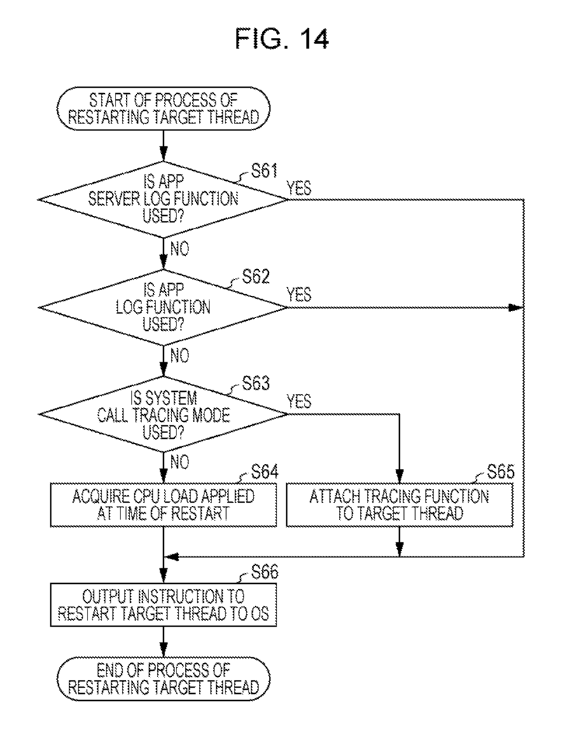

FIG. 14 illustrates an example of the process of step S53. When the app server 11 has a function (app server log function) of storing logs in the log storage unit 14, the sub-manager 13 determines whether or not the app server log function is used (in step S61).

The app server log function is a function of storing the execution states of the threads by the app server 11 in the log storage unit 14. The app server log function is a function of the app server 11.

For example, when the app server 11 does not have the app server log function, the sub-manager 13 determines that the app server log function is not used (NO in step S61). In this case, the app server log function is not used.

When the application has a function (app log function) of storing logs in the log storage unit 14, the sub-manager 13 determines that the app log function is used (in step S62).

The app log function is a function of storing the execution states of the threads by the application in the log storage unit 14. The app log function is a function of the application that operates in the server 3.

For example, when the application does not have the app log function, the sub-manager 13 determines that the app log function is not used (NO in step S62). In this case, the app log function is not used.

When the answer to step S62 is NO, the app server log function and the app log function are not used. In this case, the sub-manager 13 determines whether or not a system call tracing function is used (in step S63).

Whether or not the system call tracing function is used may be set in the sub-manager 13 in advance. The system call tracing function is a function of tracing the execution of a system call.

When the sub-manager 13 does not use the system call tracing function (NO in step S63), the sub-manager 13 acquires a CPU load applied at the time of the restart (in step S64). For example, the sub-manager 13 may acquire the CPU load from the OS of the server 3.

When the sub-manager 13 uses the system call tracing function (YES in step S63), the sub-manager 13 attaches the system call tracing function to the target thread (in step S65). Thus, the system call tracing function is used.

When the answer to step S61 is YES, when the answer to step S62 is YES, when step S64 is executed, or when step S65 is executed, the sub-manager 13 outputs an instruction to restart the target thread to the OS (in step S66). Thus, the target thread restarts operating.

Example of Process of Confirming Execution States

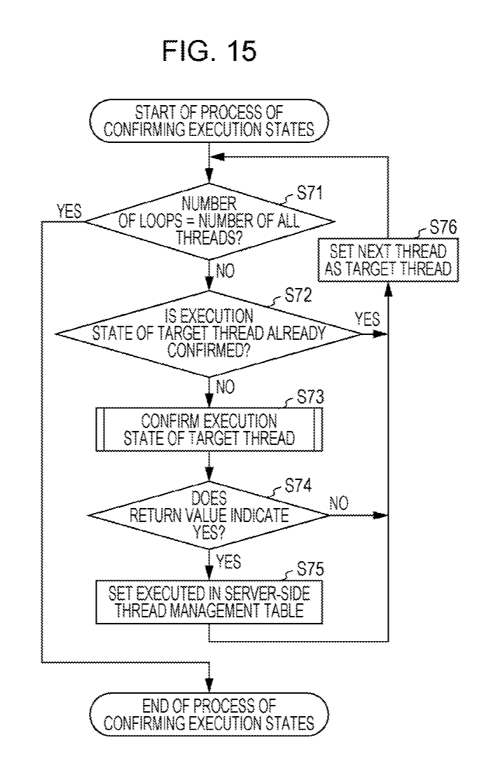

Next, an example of a process of confirming the execution states is described with reference to a flowchart of FIG. 15. The process of confirming the execution states is executed by the sub-manager 13 based on an execution state confirmation instruction from the server control device 5.

The sub-manager 13 determines whether or not the number of loops has reached the number of all the threads (in step S71). The number of loops is the number of times steps S72 to S76 are executed.

The sub-manager 13 sets one of the threads of the application as a target thread. The sub-manager 13 determines whether or not the execution state of the target thread is already confirmed (in step S72).

When the execution confirmation of the target thread does not indicate “executed” in the server-side thread management table (NO in step S72), the sub-manager 13 confirms the execution state of the target thread (in step S73).

When the sub-manager 13 confirms that the target thread is already executed, based on the execution state of the target thread, the sub-manager 13 sets a return value at “YES”. On the other hand, when the sub-manager 13 confirms that the target thread is not executed, the sub-manager 13 sets the return value at “NO”.

The sub-manager 13 determines whether the return value indicates “Yes” (in step S74). When the return value indicates “YES” (YES in step S74), the sub-manager 13 sets the execution confirmation of “executed” in the server-side thread management table (in step S75).

Specifically, the sub-manager 13 sets “executed” in a cell corresponding to the target thread and included in the execution confirmation field in the server-side thread management table. When the process of step S75 is executed or the answer to step S74 is NO, the sub-manager 13 sets a next one of the threads as the target thread (in step S76).

When the number of loops reached the number of all the threads (YES in step S71), the process of confirming the execution states is terminated. Thus, the processes of steps S72 to S76 are not executed on the executed threads among the threads of the application.

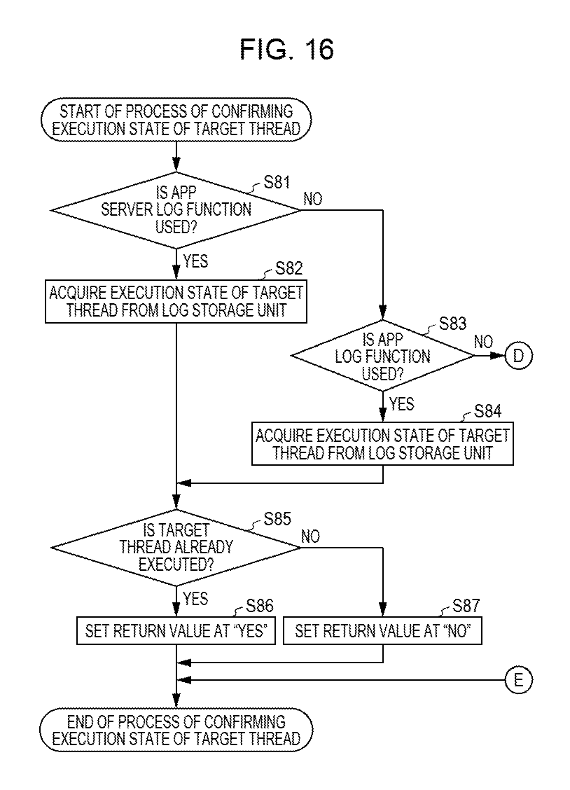

FIG. 16 illustrates an example of the process of step S73. The sub-manager 13 determines whether or not the app server log function is used (in step S81).

When the app server log function is used (YES in step S81), the sub-manager 13 acquires the execution state of the target thread from the app server logs stored in the log storage unit 14 (in step S82). Thus, the sub-manager 13 confirms the execution state of the target thread.

When the app server log function is not used (NO in step S81), the sub-manager 13 determines whether or not the app log function is used (in step S83).

When the app log function is used (YES in step S83), the sub-manager 13 acquires the execution state of the target thread from the app logs stored in the log storage unit 14 (in step S84). Thus, the sub-manager 13 confirms the execution state of the target thread.

In both cases where the app server log function is used and where the app log function is used, the sub-manager 13 confirms the execution state of the target thread based on logs stored in the log storage unit 14.

In this way, the sub-manager 13 determines whether or not the target thread is already executed (in step S85). When the sub-manager 13 confirms that the target thread is already executed (YES in step S85), the sub-manager 13 sets the return value at “YES” (in step S86).

When the sub-manager 13 confirms that the target thread is not executed (NO in step S85), the sub-manager 13 sets the return value at “NO” (in step S87). Thus, the execution state of the target thread is confirmed based on the logs.

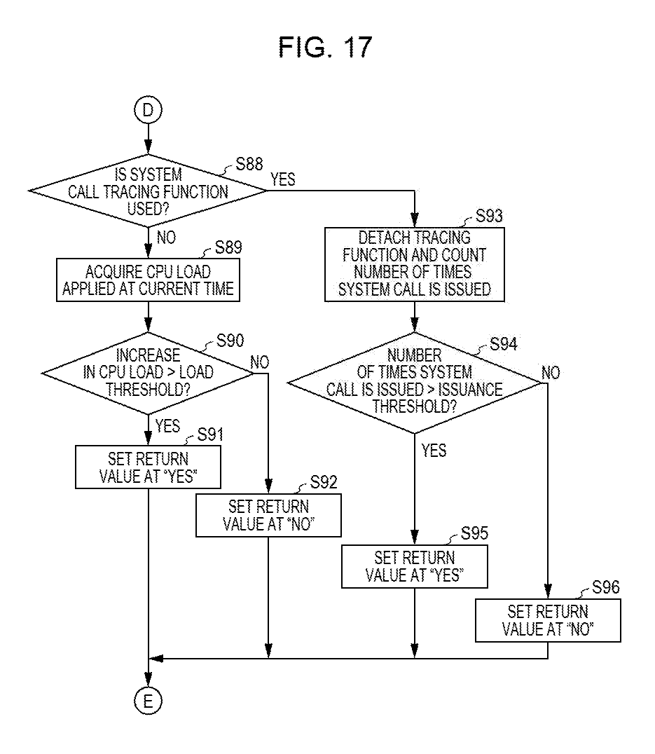

When the answer to step S83 is NO, the execution state of the target thread is not confirmed based on the logs. In this case, the process proceeds to “D”. Processes after “D” are described below with reference to a flowchart of FIG. 17.

The sub-manager 13 determines whether or not the system call tracing function is used (in step S88). When the system call tracing function is not used (NO in step S88), the sub-manager 13 uses a function of the OS of the server 3 to acquire a CPU load applied at the current time, for example (in step S89).

In step S64, the sub-manager 13 has acquired the CPU load applied at the time of the restart of the operation of the thread. The sub-manager 13 subtracts the CPU load applied at the time of the restart of the thread from the CPU load applied at the current time, thereby calculating an increase in the CPU load.

The sub-manager 13 determines whether or not the increase in the CPU load exceeds a load threshold (in step S90). When the increase in the CPU load exceeds the load threshold (YES in step S90), the sub-manager 13 sets the return value at “YES” (in step S91).

In this case, since the CPU load caused by the target thread increases, the sub-manager 13 estimates that the target thread is executed. Thus, the return value is set at “Yes”.

On the other hand, when the increase in the CPU load is equal to or smaller than the load threshold (NO in step S90), the CPU load does not increase or slightly increases and the sub-manager 13 estimates that the target thread is not executed. Thus, the sub-manager 13 sets the return value at “NO” (in step S92).

The determination of step S90 may be made based on whether or not the amount of a hardware resource of the server 3 used by the target thread exceeds a predetermined threshold. For example, whether or not the target thread was executed may be confirmed based on whether or not the amount of a memory in the server 3 used by the target thread exceeds a predetermined threshold.

When the sub-manager 13 uses the system call tracing function (YES in step S88), the sub-manager 13 detaches the tracing function and counts the number of times a system call is issued (in step S93).

The sub-manager 13 determines whether or not the number of times a system call is issued exceeds the issuance threshold (in step S94). When the number of the times a system call is issued exceeds the issuance threshold (YES in step S94), the sub-manager 13 estimates that the target thread has been executed. Thus, the sub-manager 13 sets the return value at “YES” (in step S95).

When the number of the times a system call is issued is equal to or smaller than the issuance threshold (NO in step S94), the sub-manager 13 estimates that the target thread is not executed. Thus, the sub-manager 13 sets the return value at “NO” (in step S96).

Example of Process of Restarting All Threads

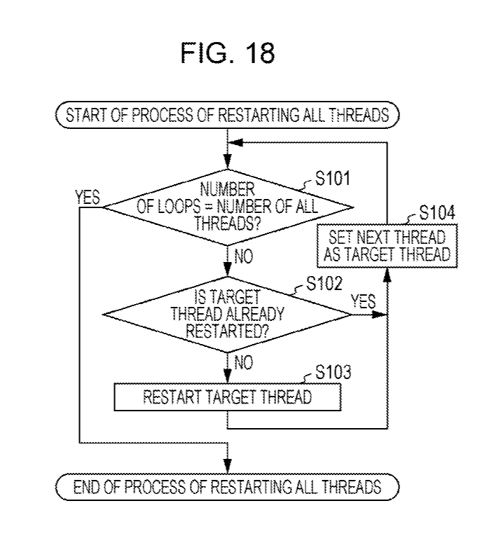

Next, an example of a process of restarting all the threads is described with reference to a flowchart of FIG. 18. The process of restarting all the threads is executed by the sub-manager 13 based on an instruction from the restart instructing unit 26 of the server control device 5.

The sub-manager 13 determines whether or not the number of loops reached the number of all the threads (in step S101). The number of loops is the number of times the processes of steps S102 to S104 are executed.

The sub-manager 13 sets one of the threads of the application as a target thread. The sub-manager 13 determines whether or not the target thread is already restarted (in step S102).

When the target thread is not restarted (NO in step S102), the sub-manager 13 restarts the target thread (in step S103). In this case, the sub-manager 13 restarts the target thread by outputting an instruction to restart the target thread to the OS executed in the server 3.

When step S103 is executed or the answer to step S102 is YES, the sub-manager 13 sets next one of the threads as the target thread (in step S104). When the number of loops reached the number of all the threads (YES in step S101), the process of restarting all the threads is terminated.

Example of Hardware Configuration of Server Control Device

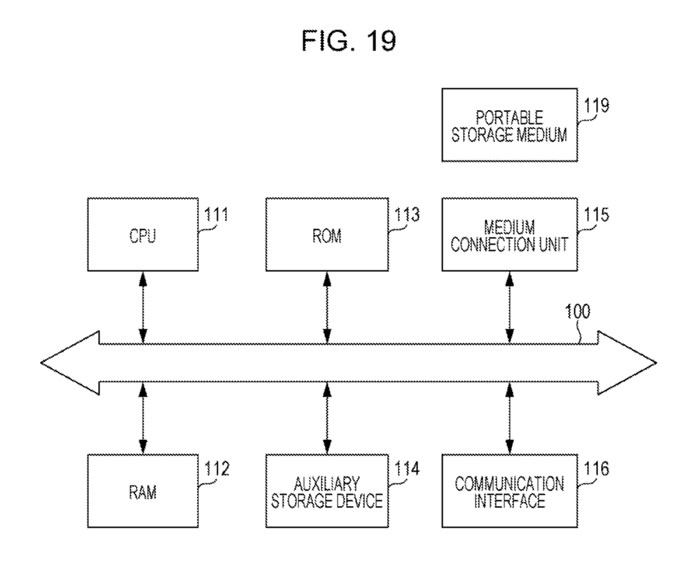

Next, an example of a hardware configuration of the server control device 5 is described with reference to an example of FIG. 19. As illustrated in the example of FIG. 19, a CPU 111, a RAM 112, a ROM 113, an auxiliary storage device 114, a medium connection unit 115, and a communication interface 116 are connected to a bus 100.

The CPU 111 is an arbitrary processing circuit. The CPU 111 executes a program loaded in the RAM 112. As the program to be executed, a server control program for executing the process according to the embodiment may be applied. The ROM 113 is a nonvolatile storage device for storing the program to be loaded in the RAM 112.

The auxiliary storage device 114 stores information of various types. A hard disk drive, a semiconductor memory, or the like may be applied to the auxiliary storage device 114, for example. The medium connection unit 115 may be connected to a portable storage medium 119.

As the portable storage medium 119, a portable memory or an optical disc (for example, a compact disc (CD), a digital versatile disc (DVD), or the like) may be applied. The program for executing the process according to the embodiment may be stored in the portable storage medium 119.

The main control unit 21, the thread number acquiring unit 22, the stop instructing unit 23, the request transmitting unit 24, the determining unit 25, and the restart instructing unit 26 that are included in the server control device 5 may be achieved by causing the CPU 111 to execute a given program.

The control-side table storage unit 27 may be achieved by the RAM 112, the auxiliary storage device 114, or the like. The communicating unit 28 may be achieved by the communication interface 116.

The RAM 112, the ROM 113, the auxiliary storage device 114, and the portable storage medium 119 are examples of a computer-readable tangible storage medium. The tangible storage media are not transitory media such as signal carrier waves.

Others

The embodiment is not limited to the above description and may include various configurations and embodiments without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
acquiring a number of executable units of application programs to be executed by a server, in response to a notification indicating completion of initialization of the application programs; and
performing a post-initialization control including:
transmitting, to the server, a stop instruction to stop operations of all the executable units to be executed by the server,
transmitting, to the server, requests whose number is equal to or greater than the acquired number of the executable units, and
transmitting, to the server, a restart instruction to restart operations of all the executable units that have been stopped.

2. The non-transitory, computer-readable recording medium of claim 1, the process further comprising:
receiving, from the server, responses responsive to the requests transmitted to the server; and
determining, based on a number of the received responses and a number of the transmitted requests, whether all the executable units have been executed in accordance with the requests.

3. The non-transitory, computer-readable recording medium of claim 2, the process further comprising:
when it is determined that there exists at least one executable unit that has not been executed yet, repeating the post-initialization control until all the executable units execute the request

4. The non-transitory, computer-readable recording medium of claim 3, the process further comprising:
transmitting, to the server, an instruction to restart operations of executable units other than executable units that have been already executed.

5. The non-transitory, computer-readable recording medium of claim 1, the process further comprising:
determining whether an executable unit has been executed, based on whether or not an increase in a used amount of a hardware resource of the server for the executable unit exceeds a predetermined threshold.

6. The non-transitory, computer-readable recording medium of claim 1, the process further comprising:
determining whether an executable unit has been executed, based on whether or not a number of times a system call has been issued for the executable unit by the server exceeds a predetermined threshold.

7. A server control method by which a computer executes a process, the process comprising:
acquiring a number of executable units of application programs to be executed by a server, in response to a notification indicating completion of initialization of the application programs;
transmitting, to the server, a stop instruction to stop operations of all the executable units to be executed by the server;
transmitting, to the server, requests whose number is equal to or greater than the acquired number of the executable units; and
transmitting, to the server, a restart instruction to restart operations of all the executable units that have been stopped.

8. An apparatus comprising:
a processor configured to:
acquire a number of executable units of application programs to be executed by a server, in response to a notification indicating completion of initialization of the application programs,
transmit, to the server, a stop instruction to stop operations of all the executable units to be executed by the server,
transmit, to the server, requests whose number is equal to or greater than the acquired number of the executable units, and
transmit, to the server, a restart instruction to restart operations of all the executable units that have been stopped.
